(19) United States
(12) Patent Application Publication
(10) Pub. No.: US 2018/0274265 A1
(43) Pub. Date: Sep. 27, 2018

(54) ROTARY LOCKING DEVICE

(71) Applicant: FIVETECH TECHNOLOGY INC., New Taipei City (TW)

(72) Inventors: TING-JUI WANG, NEW TAIPEI CITY (TW); PEI-HSUN LIN, NEW TAIPEI CITY (TW); WEI-CHEN HUANG, NEW TAIPEI CITY (TW)

(21) Appl. No.: 15/927,409

(22) Filed: Mar. 21, 2018

(30) Foreign Application Priority Data
Mar. 24, 2017 (TW) 106204224

(51) Int. Cl. E05B 17/22; E05B 63/16; E05B 13/00; E05B 63/00

(52) U.S. Cl. CPC E05B 17/22; E05B 63/0065; E05B 13/004; E05B 63/16

(57) ABSTRACT

A rotary locking device includes a thumbturn member, a latch member held to and turnable by the thumbturn member, and a limiting structure provided on the thumbturn member for movably connecting to or interfering with the thumbturn member. The rotary locking device can be mounted on a first object, and the thumbturn member can be turned for the latch member to turn to a position to lock a second object, so that the first and the second object are quickly and easily locked to each other. The limiting structure limits an angle by which the thumbturn member or the latch member can be turned. When the thumbturn member is turned reversely, the latch member is brought to unlock the second object, so that the first and the second object are quickly and easily separated from each other.

### CROSS-REFERENCE TO RELATED APPLICATION

This non-provisional application claims priority under 35 U.S.C. § 119(a) on Patent Application No(s).106204224 filed in Taiwan, R.O.C. on Mar. 24, 2017, the entire contents of which are hereby incorporated by reference.

### FIELD OF THE INVENTION

The present invention relates to a thumbturn locking device, and more particularly, to a rotary locking device that enables two objects to be quickly and easily locked to or unlocked from each other.

### BACKGROUND OF THE INVENTION

According to the currently available locking and fastening techniques, screws are usually used to directly fasten two objects together, or a locking device is used to lock two objects to each other. While two objects can be effectively connected or fastened together using screws or a locking device, it is troublesome to separate the two objects from each other because the screws must be removed using a tool or a key for unlocking is required. Further, currently, there is not any special design that facilitates easy and quick locking and unlocking of an object to and from another object.

Therefore, it is tried by the inventor to develop a rotary locking device to overcome the disadvantages of the conventional locking means.

### SUMMARY OF THE INVENTION

A primary object of the present invention is to provide a rotary locking device that enables two objects to be quickly and easily locked to or unlocked from each other.

To achieve the above and other objects, the rotary locking device provided according to the present invention includes a thumbturn member, a latch member held to and turnable by the thumbturn member, and a limiting structure provided on the thumbturn member for movably connecting to or interfering with the thumbturn member.

According to the rotary locking device of the present invention, the thumbturn member includes a knob portion and a shaft portion connected to the knob portion.

According to the rotary locking device of the present invention, the knob portion is provided with a grip portion.

According to the rotary locking device of the present invention, the limiting structure includes a locating seat.

According to the rotary locking device of the present invention, the limiting structure includes a turning element having a sleeve portion, through which the shaft portion of the thumbturn member is extended.

According to the rotary locking device of the present invention, the limiting structure includes a connecting portion.

According to the rotary locking device of the present invention, the shaft portion is provided with an engaging section.

According to the rotary locking device of the present invention, on the engaging section, there are mounted a plurality of washers pressed against the latch member, a plurality of elastic elements pressed against the washers, and a plurality of fixing elements tightened against the shaft portion. The washers, the elastic elements and the fixing elements together firmly hold the latch member to the shaft portion, such that the latch member can be brought by the thumbturn member to turn.

According to the rotary locking device of the present invention, the elastic elements can be disc springs, coil springs, C-shaped springs, wave springs or torsion springs.

According to the rotary locking device of the present invention, the fixing elements can be bolts.

According to the rotary locking device of the present invention, the limiting structure includes a mating limiting section and a limiting section. The mating limiting section and the limiting section are provided on the thumbturn member and can be engaged with each other to limit the thumbturn member from being excessively turned.

According to the rotary locking device of the present invention, the mating limiting section can be a pressing element or a stop block mounted on the thumbturn member.

According to the rotary locking device of the present invention, the shaft portion is provided at an end with an engaging section for connecting to the latch member.

According to the rotary locking device of the present invention, the engaging section can be a toothed section, a threaded section, a fastening section, a recessed section, a protruded section or a post-shaped section.

According to the rotary locking device of the present invention, the latch member is provided at an inner corner with a guide portion.

According to the rotary locking device of the present invention, the limiting structure includes a body portion and a stop portion extended from and located at an end surface of the body portion, and the stop portion is used to limit the latch member from being rotated or to limit an angle by which the latch member can be rotated.

According to the rotary locking device of the present invention, an elastic element is disposed between the thumbturn member and the latch member, or between the thumbturn member and the limiting structure, or between the limiting structure and the latch member.

According to the rotary locking device of the present invention, the elastic element can be a torsion spring, a coil spring, a flat spring, a washer, a gasket or an elastic bar.

According to the rotary locking device of the present invention, the connecting portion of the limiting structure is provided with a material retaining section.

According to the rotary locking device of the present invention, the material retaining section has a material retaining space formed thereon.

According to the rotary locking device of the present invention, the material receiving space is used to fixedly retain therein part of a material of an object, such that the connecting portion is firmly connected to the object.

According to the rotary locking device of the present invention, the connecting portion is connected to and radially outward pressed against the object, such that part of the material of the object is forced into the material retaining space, enabling the connecting portion to be firmly held to the object.

According to the rotary locking device of the present invention, the connecting portion can be assembled to the object by way of riveting, expansion connection, screw-fastening, welding, snap-on fastening or glue bonding.

According to the rotary locking device of the present invention, the material retaining space is formed on the connecting portion when a force is applied to the connecting portion by a pressing member, and the material retaining space so formed can retain therein part of the material of the object, enabling the connecting portion to be firmly held to the object.

According to the rotary locking device of the present invention, the latch member can be configured as an L-shaped plate, a tongue-like plate, a male retaining member, a female retaining member, an externally threaded member, an elastic fastening member, a hook member, an externally toothed member, a post-like member or a block-like member.

According to the rotary locking device of the present invention, the connecting portion has a weldable surface, which can be heated for welding to a surface or a through hole of an object.

According to the rotary locking device of the present invention, the rotary locking device can be individually disposed in a carrier and be removed from the carrier using a tool for placing on and welding to the object.

According to the rotary locking device of the present invention, the latch member is provided with a mating stop portion for pressing against the stop portion of the limiting structure, so as to limit the angle by which the latch member can be rotated.

According to the rotary locking device of the present invention, the limiting structure is provided with stopper-receiving sections and the latch member is provided with a stopper corresponding to the stopper-receiving sections. The stopper can be aligned with one of the stopper-receiving sections and be interfered by the stopper-receiving section, so that the latch member is held to a position relative to an object to unlock or lock the object.

According to the rotary locking device of the present invention, the connecting portion of the limiting structure is provided with a directional section. When the connecting portion is connected to an object, the directional section matches a mating directional section provided on the object and thereby determines a directional position of the limiting structure relative to the object.

With these arrangements, the rotary locking device of the present invention can be mounted on a first object, and the thumbturn member can be turned for the latch member to turn to a position for locking a second object, so that the first and the second object are quickly and easily locked to each other. And, the limiting structure can limit an angle by which the thumbturn member or the latch member can be turned. When the thumbturn member is turned reversely, the latch member is brought to unlock the second object, so that the first and the second object are quickly and easily separated from each other.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a rotary locking device according to a first embodiment of the present invention;

FIG. 2 is an assembled view of the rotary locking device of FIG. 1 viewed from a front side thereof;

FIG. 3 is an assembled view of the rotary locking device of FIG. 1 viewed from a rear side thereof;

FIG. 4 is a fragmentary, enlarged view of the rotary locking device of FIG. 1;

FIG. 5 is an exploded perspective view of a rotary locking device according to a second embodiment of the present invention;

FIG. 6 is an assembled front view of the rotary locking device of FIG. 5;

FIG. 7 shows the manner of closing and opening the rotary locking device of FIG. 5;

FIG. 8 shows the manner of closing and opening the rotary locking device of FIG. 5;

FIG. 9 shows the manner of closing and opening the rotary locking device of FIG. 5;

FIG. 10 is an exploded perspective view of a rotary locking device according to a third embodiment of the present invention;

FIG. 11 is an assembled front perspective view of the rotary locking device of FIG. 10;

FIG. 12 is a top view of a rotary locking device according to a fourth embodiment of the present invention;

FIG. 13 is a sectional top view of the rotary locking device of FIG. 12;

FIG. 14 shows the manner of closing the rotary locking device of FIG. 12;

FIG. 15 shows the manner of opening the rotary locking device of FIG. 12;

FIG. 16 is a sectional top view of a rotary locking device according to a fifth embodiment of the present invention;

FIG. 17 shows the use of a rotary locking device according to a sixth embodiment of the present invention;

FIG. 18 shows the use of a rotary locking device according to a seventh embodiment of the present invention;

FIG. 19 shows the use of a rotary locking device according to an eighth embodiment of the present invention;

FIG. 20 shows the use of a rotary locking device according to a ninth embodiment of the present invention;

FIG. 21 shows the use of a rotary locking device according to a ninth embodiment of the present invention;

FIG. 22 shows examples of differently configured latch members for the rotary locking device of the present invention;

FIG. 23 is a rear view of a rotary locking device according to a tenth embodiment of the present invention;

FIG. 24 is a sectional top view of the rotary locking device of FIG. 23; and

FIG. 25 shows a limiting structure for a rotary locking device according to an eleventh embodiment of the present invention.

### DETAILED DESCRIPTION OF THE PREFERRED EMBODIMENTS

The present invention will now be described with some preferred embodiments thereof and by referring to the accompanying drawings.

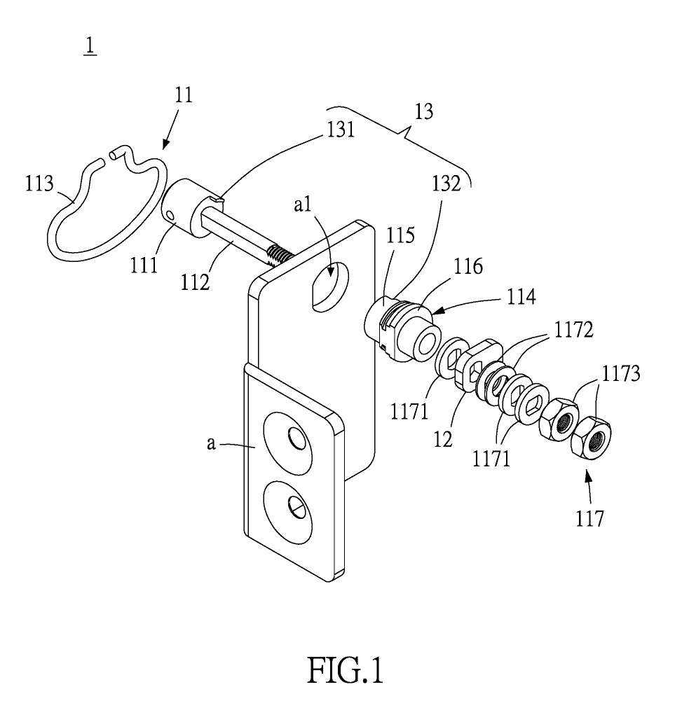

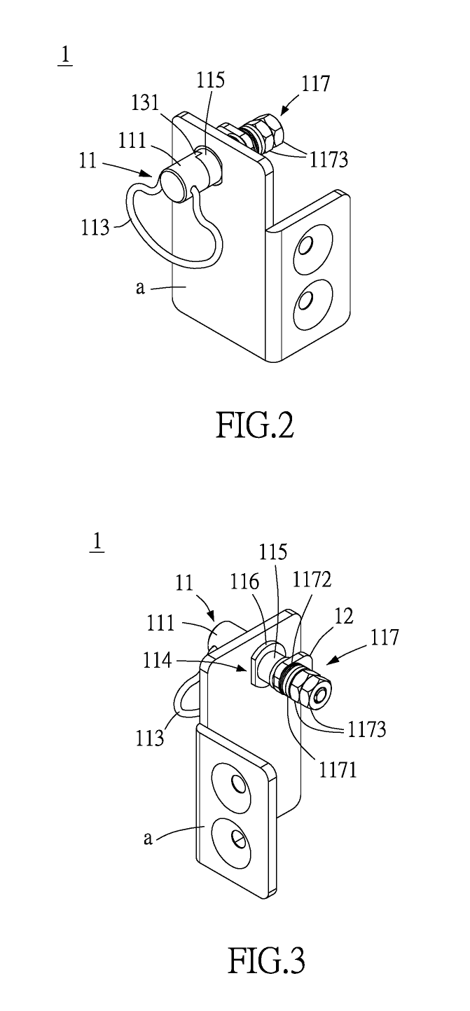

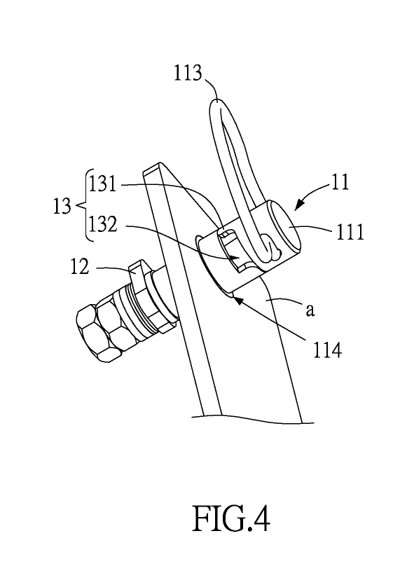

Please refer to FIGS. 1 to 4, which are exploded perspective view, assembled front perspective view, assembled rear perspective view and fragmentary enlarged view, respectively, of a rotary locking device 1 according to a first embodiment of the present invention. As shown, the rotary locking device 1 in the first embodiment includes a thumbturn member 11, a latch member 12 and a limiting structure 13.

The thumbturn member 11 includes a knob portion 111 and a shaft portion 112 connected to the knob portion 111. The knob portion 111 is provided with a grip portion 113, and the shaft portion 112 is rotatably connected to a seat portion 114. The seat portion 114 includes a sleeve 115, through which the shaft portion 112 is extended, and a connecting portion 116 fitted around the sleeve 115. In the first embodiment, the connecting portion 116 is an externally D-shaped annular member. Further, the shaft portion 112 is provided with an engaging section 117. On the engaging section 117, there are mounted a plurality of washers 1171 pressed against the latch member 12, a plurality of elastic elements 1172 pressed against the washers 1171, and a plurality of fixing elements 1173 tightened against the shaft portion 112. The washers 1171, the elastic elements 1172 and the fixing elements 1173 together firmly hold the latch member 12 to the shaft portion 112, such that the latch member 12 can be brought by the thumbturn member 11 to turn. The elastic elements 1172 can be disc springs, coil springs, C-shaped springs, wave springs or torsion springs; and the fixing elements 1173 can be bolts.

The latch member 12 is held to the thumbturn member 11 and can be brought by the thumbturn member 11 to turn. The fixing elements 1173 on the engaging section 117 provide a locking force that is applied to and compresses the elastic elements 1172 for the same to exert an increased holding force on the latch member 12, and the holding force is strong enough to firmly hold the latch member 12 to the shaft portion 112 and accordingly allow the thumbturn member 11 to bring the latch member 12 to rotate along with it.

The limiting structure 13 is provided on the thumbturn member 11 for limiting an angular range by which the thumbturn member 11 can be turned. The limiting structure 13 includes a mating limiting section 131 provided on the knob portion 111 and a limiting section 132 provided on the seat portion 114.

When using the first embodiment of the rotary locking device 1 of the present invention, the seat portion 114 of the thumbturn member 11 is connected to an object “a”. The object “a” includes a receiving section al in the form of a D-shaped opening, to which the seat portion 114 is rotatably connected.

To close the rotary locking device 1, i.e. to lock another object (not shown) with the rotary locking device 1, a user may directly apply a force to turn the knob portion 111 or apply a force on the grip portion 113 to indirectly turn the knob portion 111. At this point, the shaft portion 112 is brought to rotate in the seat portion 114 and brings the latch member 12 to turn along with it. When the latch member 12 is turned to an outward extended position, it interferes with the other object to thereby lock the latter. The other object can be a chassis, a box, a panel, a block, a main board or an enclosure (not shown). At this point, the mating limiting section 131 of the limiting structure 13 is pressed against a sidewall of the limiting section 132 to not only limit the angular range by which the thumbturn member 11 can be turned, but also control a locked position and a locking direction of the rotary locking device 1, lest the thumbturn member 11 should be excessively turned.

To open the rotary locking device 1, i.e. to unlock the other object, simply turn the knob portion 111 reversely for the shaft portion 112 to rotate in an opposite direction and bring the latch member 12 to turn away from and unlock the other object. At this point, the mating limiting section 131 of the limiting structure 13 is pressed against an opposite sidewall of the limiting section 132 to not only limit the angular range by which the thumbturn member 11 can be turned, but also control an unlocked position and an unlocking direction of the rotary locking device 1, lest the thumbturn member 11 should be excessively turned. Meanwhile, the object “a” can be separated from the other object. Therefore, with the arrangements of the present invention, an object can be quickly and easily fastened to or released from another object.

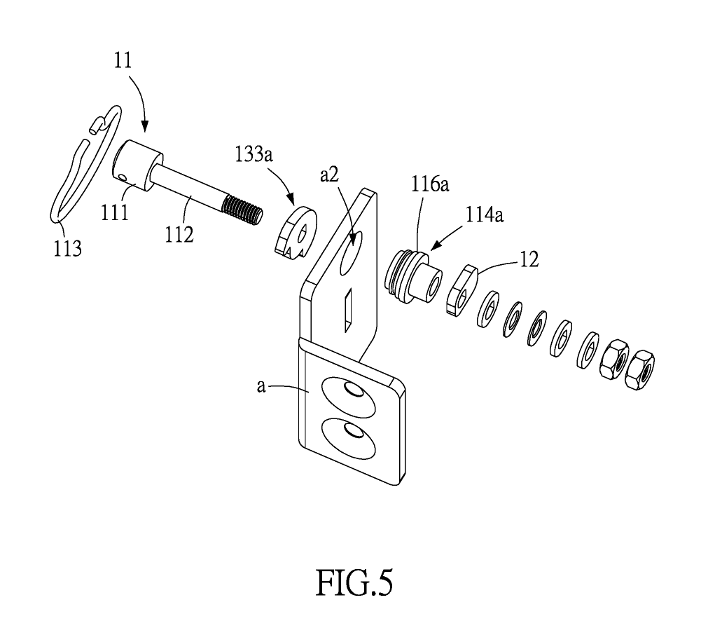

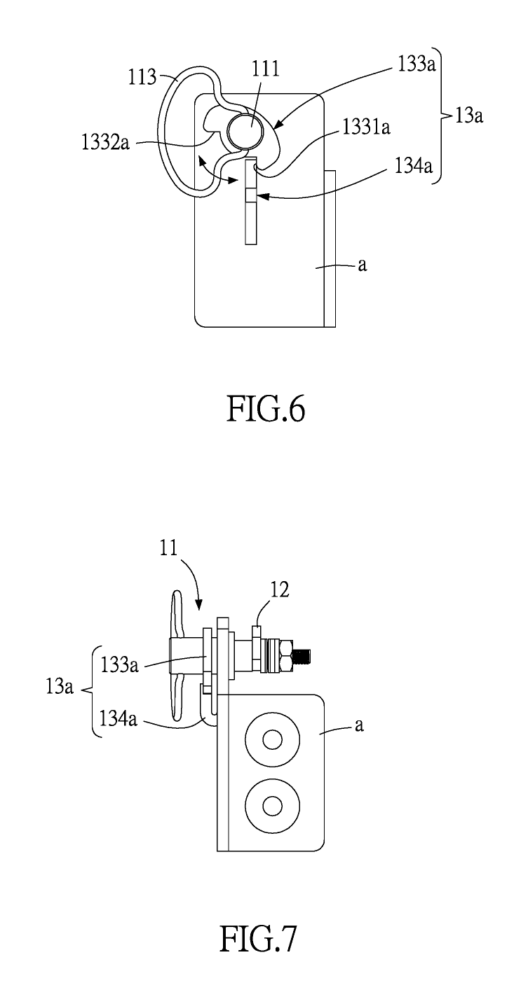

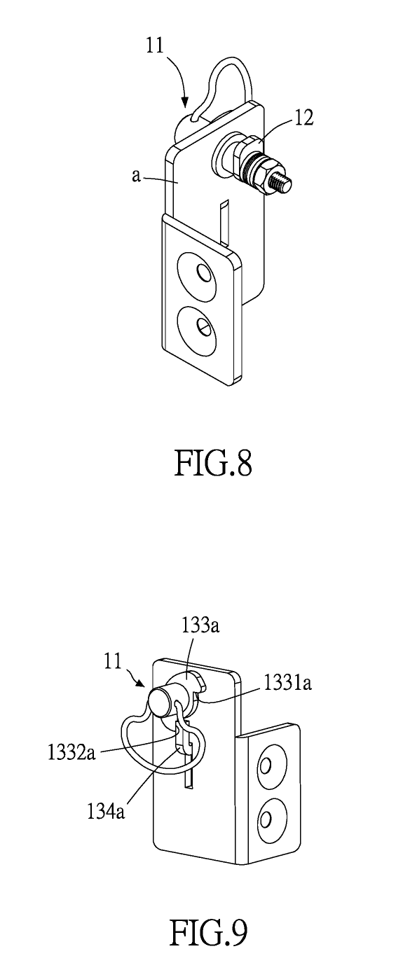

Please refer to FIGS. 5 and 6, which are exploded perspective view and assembled front view, respectively, of a rotary locking device 1 according to a second embodiment of the present invention; and to FIGS. 7 to 9, which show the manner of closing and opening the second embodiment of the rotary locking device 1. As shown, in addition to the first embodiment, the rotary locking device of the present invention can be otherwise configured as the second embodiment. However, unlike the first embodiment, the rotary locking device 1 in the second embodiment includes a seat portion 114a having a connecting portion 116a in the form of a round annular member, and a limiting structure 13a including a movable pressing element 133a provided on the knob portion 111 and a fixed stopping element 134a provided on the object “a”. The pressing element 133a has a first pressing edge 1331a and an opposite second pressing edge 1332a, which interfere with the stopping element 134a. To correspond to the round-annular connecting portion 116a, the object “a” has a receiving section a2 in the form of a round opening.

In the second embodiment, when the latch member 12 is brought by the thumbturn member 11 to turn to a locked position, the first pressing edge 1331a of the pressing element 133a of the limiting structure 13a is pressed against one lateral side of the stopping element 134a to limit the angular range by which the thumbturn member 11 can be turned to lock the other object; or when the latch member 12 is brought by the thumbturn member 11 to turn to an unlocked position, the second pressing edge 1332a of the pressing element 133a of the limiting structure 13a is pressed against the other lateral side of the stopping element 134a to limit the angular range by which the thumbturn member 11 can be turned to unlock the other object. Therefore, with the second embodiment, it is also able to limit an angular range by which the thumbturn member 11 can be turned and to control locked/unlocked positions and locking/unlocking directions of the rotary locking device 1, lest the thumbturn member 11 should be excessively turned.

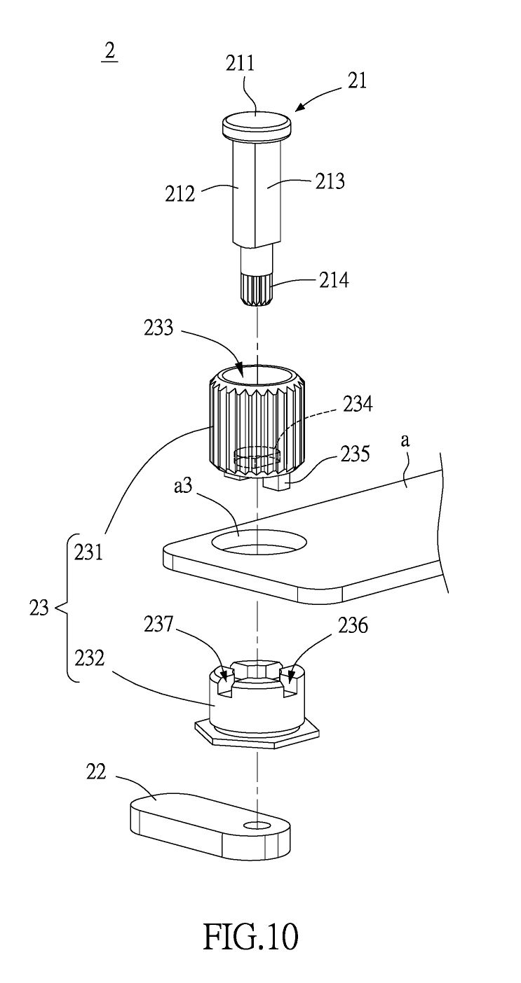

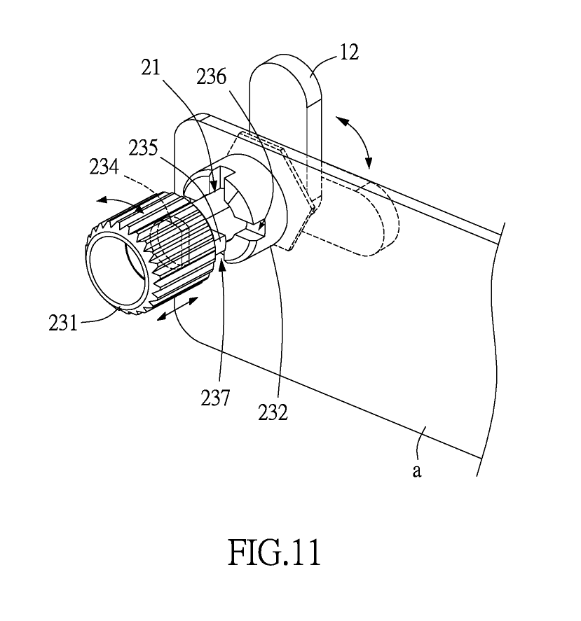

Please refer to FIGS. 10 and 11, which are exploded perspective view and assembled front perspective view, respectively, of a rotary locking device 2 according to a third embodiment of the present invention. As shown, in addition to the first and the second embodiment, the rotary locking device of the present invention can be otherwise configured as the third embodiment. In the third embodiment, the rotary locking device is denoted a reference number 2 and includes a thumbturn member 21, a latch member 22 and a limiting structure 23. The thumbturn member 21 includes a knob portion 211 and a shaft portion 212. The shaft portion 212 is provided with a limiting surface 213 and is formed at a free end with an engaging section 214 for engaging with the latch member 22. The engaging section 214 can be a toothed section, a threaded section, a fastening section, a recessed section, a protruded section or a post-shaped section. The limiting structure 23 includes a turning element 231 and a locating seat 232. The turning element 231 includes a sleeve portion 233, which is movably fitted around the shaft portion 212, such that the turning element 231 can move on along the thumbturn member 21 and bring the thumbturn member 21 to rotate. Further, the sleeve portion 233 is provided with an insertion section 234, which is in contact with and connected to the limiting surface 213 on the shaft portion 212. In the third embodiment, the insertion section 234 is in the form of a D-shaped opening. The turning element 231 further includes at least one interfering portion 235. The locating seat 232 is provided with a first limiting notch 236 and a second limiting notch 237 for detachably engaging with the interfering portion 235 of the turning element 231 of the limiting structure 23. The rotary locking device 2 in the third embodiment is mounted on an object “a” by fixedly assembling the locating seat 232 to a through hole a3 formed on the object “a”.

According to the third embodiment, to close the rotary locking device 2, i.e. to lock another object (not shown) with the rotary locking device 2, a user first axially pulls the turning element 231 and uses the knob portion 211 to limit a distance by which the turning element 231 can be pulled outward relative to the thumbturn member 21, such that the interfering portion 235 of the turning element 231 is moved out of the first limiting notch 236 on the locating seat 232. At this point, the turning element 231 can be turned to rotate the thumbturn member 21 while aligning the interfering portion 235 with the second limiting notch 237, so that the latch member 22 is brought by the thumbturn member 21 to turn to an outward extended position to lock the other object (not shown). Thereafter, push the turning element 231 toward the locating seat 232 to engage the interfering portion 235 with the second limiting notch 237 and complete the locking operation.

According to the third embodiment, to open the rotary locking device 2, i.e. to unlock the other object, simply axially pull the turning element 231 again, so that the interfering portion 235 of the turning element 231 is moved out of the second limiting notch 237. At this point, the turning element 231 can be turned to rotate the thumbturn member 21 while aligning the interfering portion 235 with the first limiting notch 236, so that the latch member 22 is brought by the thumbturn member 21 to turn away from and unlock the other object. Thereafter, push the turning element 231 toward the locating seat 232 to engage the interfering portion 235 with the first limiting notch 236 and complete the unlocking operation.

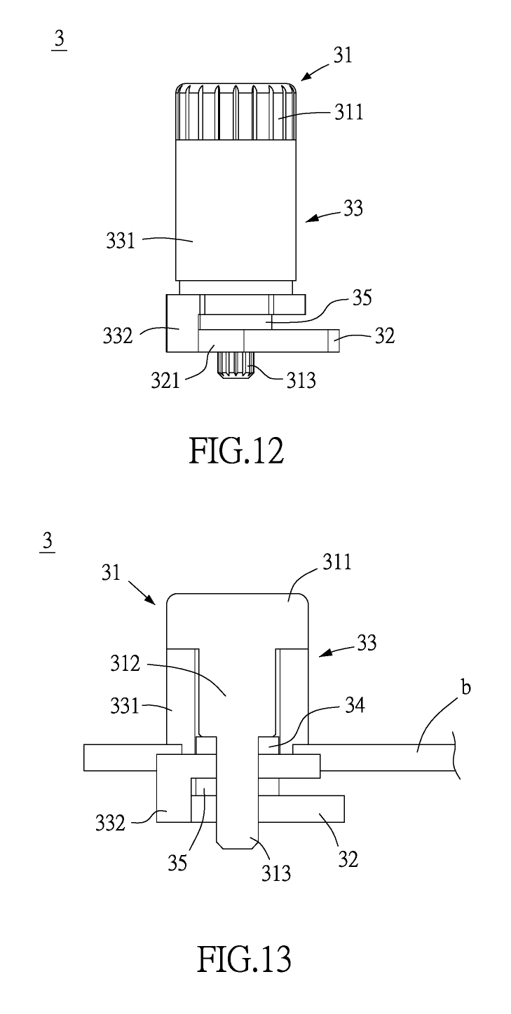

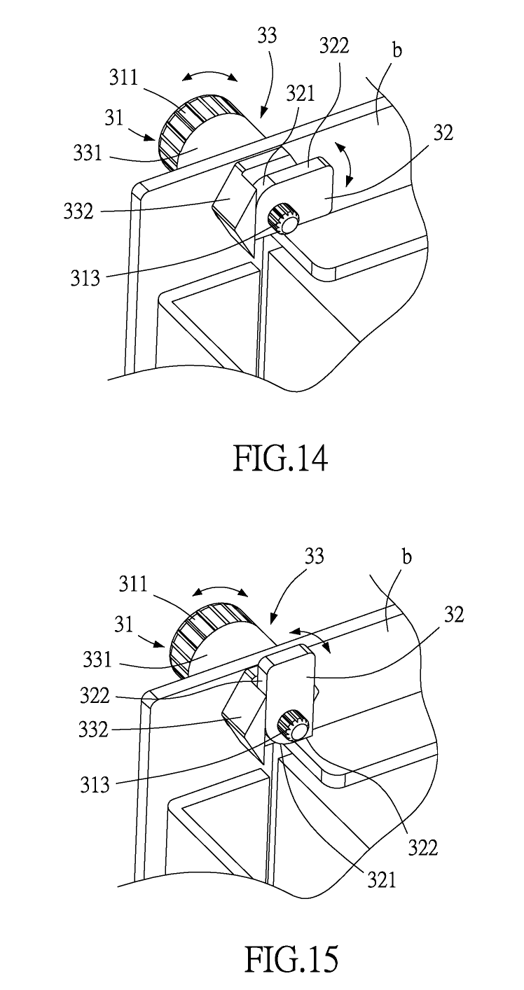

Please refer to FIGS. 12 and 13, which are top view and sectional top view, respectively, of a rotary locking device according to a fourth embodiment of the present invention, and to FIGS. 14 and 15, which show the manner of closing and opening, respectively, of the rotary locking device according to the fourth embodiment of the present invention. As shown, in addition to the first, second and third embodiments, the rotary locking device of the present invention can be otherwise configured as the fourth embodiment. In the fourth embodiment, the rotary locking device is denoted a reference number 3 and includes a thumbturn member 31, a latch member 32 and a limiting structure 33. The thumbturn member 31 includes an operating portion 311, a shaft portion 312 connected to the operating portion 311, and an engaging section 313 provided on the shaft portion 312. The engaging section 313 can be a toothed section, a threaded section, a fastening section, a recessed section, a protruded section or a post-shaped section. The latch member 32 is provided at an inner corner with a guide portion 321 and at two peripheral side walls adjacent to the guide portion 321 with a mating stop portion 322 each. The limiting structure 33 is provided on around the thumbturn member 31 for limiting the angular range by which the thumbturn member 31 can be turned. The limiting structure 33 includes a body portion 331 and a stop portion 332 extended from and located at an end surface of the body portion 331. The stop portion 332 is used to limit the latch member 32 from being rotated or to limit the angle by which the latch member 32 can be rotated. The limiting structure 33 can be turned by an angle from 5 to 355 degrees. Further, a first washer 34 is disposed between the thumbturn member 31 and the limiting structure 33, and a second washer 35 is disposed between the latch member 32 and the limiting structure 33. In the fourth embodiment, the first washer 34 is a soft washer, and the second washer 35 is a rigid washer. The rotary locking device 3 in the fourth embodiment is mounted on an object “b” by fixedly assembling the body portion 331 of the limiting structure 33 to the object “b”.

According to the fourth embodiment, to close the rotary locking device 3, i.e. to lock another object (not shown) with the rotary locking device 3, a user may directly apply a force to the operating portion 311, so that the shaft portion 312 connected to the operating portion 311 is brought to rotate in the body portion 331 of the limiting structure 33 and the latch member 32 connected to the engaging section 313 is brought by the shaft portion 312 to rotate at the same time. When the latch member 32 is turning, the guide portion 321 of the latch member 32 is brought to press against the stop portion 332 of the limiting structure 33. When the latch member 32 has been turned to an outward extended position to lock another object (not shown), one of the mating stop portions 322 of the latch member 32 is brought to press against the stop portion 332, so as to limit the angle by which the latch member 32 can be turned and to control a locked position and a locking direction of the rotary locking device 3, lest the latch member 32 should be excessively turned.

According to the fourth embodiment, to open the rotary locking device 3, i.e. to unlock the other object, simply directly apply a force to the operating portion 311, so that the shaft portion 312 is brought to rotate in the body portion 331 of the limiting structure 33 and the latch member 32 is brought by the shaft portion 312 to turn away from and unlock the other object. When the latch member 32 is turning, the guide portion 321 of the latch member 32 is brought to press against the stop portion 332 of the limiting structure 33. When the latch member 32 has been turned to unlock the other object, the other mating stop portion 322 of the latch member 32 is brought to press against the stop portion 332, so as to limit the angle by which the latch member 32 can be turned and to control an unlocked position and an unlocking direction of the rotary locking device 3, lest the latch member 32 should be excessively turned.

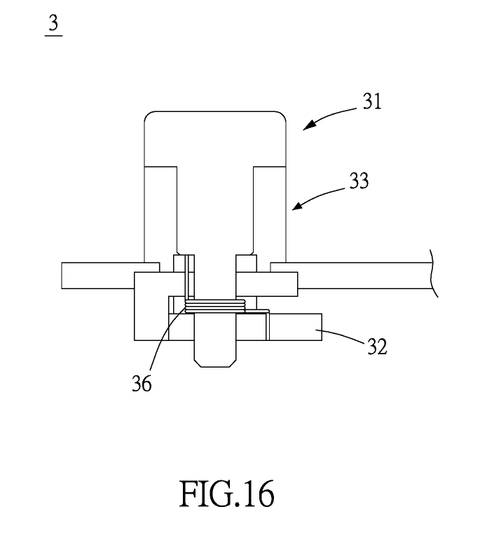

Please refer to FIG. 16, which is a sectional top view of a rotary locking device 3 according to a fifth embodiment of the present invention. As shown, in addition to the first, second, third and fourth embodiments, the rotary locking device of the present invention can be otherwise configured as the fifth embodiment. In the fifth embodiment, the rotary locking device 3 is different from the fourth embodiment in further including an elastic element 36 disposed between the thumbturn member 31 and the latch member 32. Alternatively, the elastic element 36 can be disposed between the limiting structure 33 and the latch member 32. According to the fifth embodiment, the elastic element 36 can be a torsion spring, a coil spring, a flat spring, a washer, a gasket or an elastic bar.

With this arrangement, the elastic element 36 is used to hold the latch member 32 to a normally locked or unlocked state. When the thumbturn member 31 is turned and the latch member 32 is brought to an unlocked position, the elastic element 36 is compressed. And, when the thumbturn member 31 is released after the latch member 32 is in the unlocked state, the elastic element 36 is no longer compressed, bringing the thumbturn member 31 to turn the latch member 32 back to the locked state again.

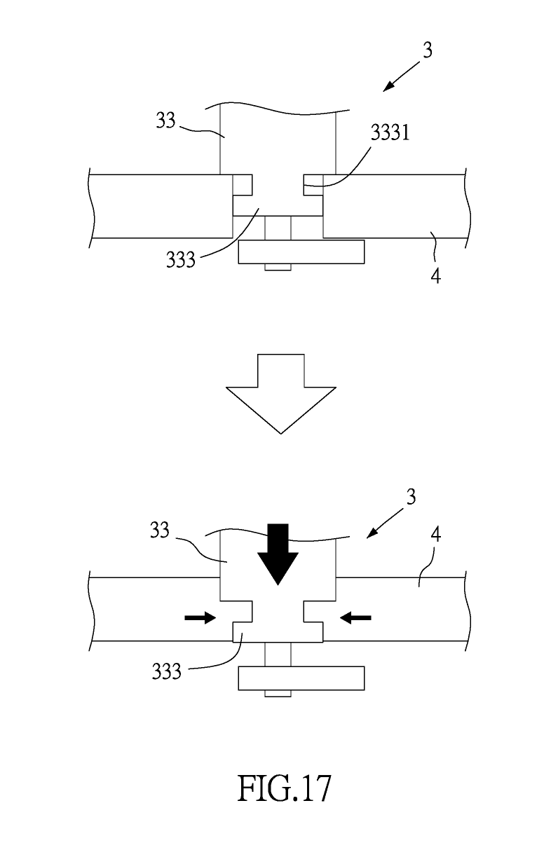

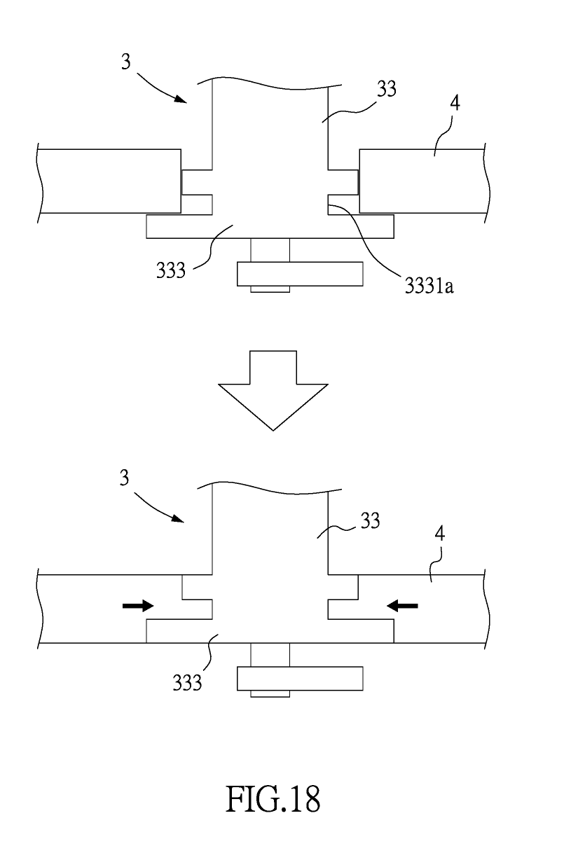

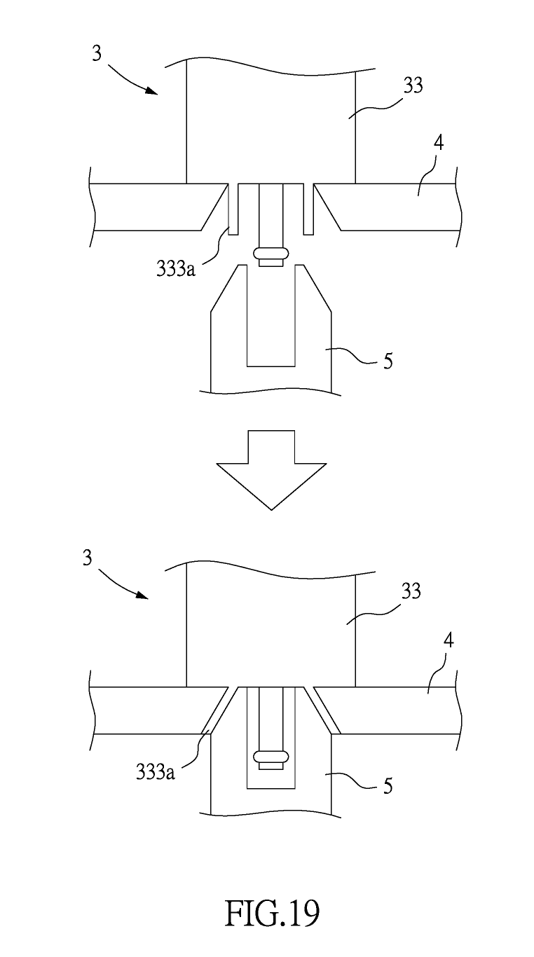

Please refer to FIGS. 17 to 19, which show the use of a rotary locking device 3 according to a sixth, a seventh and an eighth embodiment of the present invention, respectively. In FIGS. 17 and 18, the rotary locking devices 3 respectively have a limiting structure 33, which includes a connecting portion 333 provided with a material retaining section 3331 (see FIG. 17), 3331a (see FIG. 18) that has a material retaining space formed thereon. The material retaining section 3331, 3331a is configured to firmly connect to an object 4 by retaining part of the material of the object 4 thereto. In other words, when the connecting portion 333 is connected to and radially outward pressed against the object 4, part of the material of the object 4 is forced to flow into or fill with the material retaining space on the material retaining section 3331, 3331a via the limiting structure 33 compressing the object 4, so that the limiting structure 33 is held to the object 4. In FIG. 19, the limiting structure 33 is provided with a connecting portion 333a. When a force is applied to the connecting section 333a by a pressing member 5, the connecting section 333a is radially outward expanded to produce a material retaining space around it. The material retaining space is capable of retaining part of the material of the object 4 therein, such that the limiting structure 33 is held to the object 4. That is, in the eighth embodiment, the connecting section 333a is held to the object 4 by way of expansion connection. In other operable embodiments, the connecting section 333 can be assembled to the object 4 by way of riveting, screw-fastening, snap-on fastening or glue bonding (not shown).

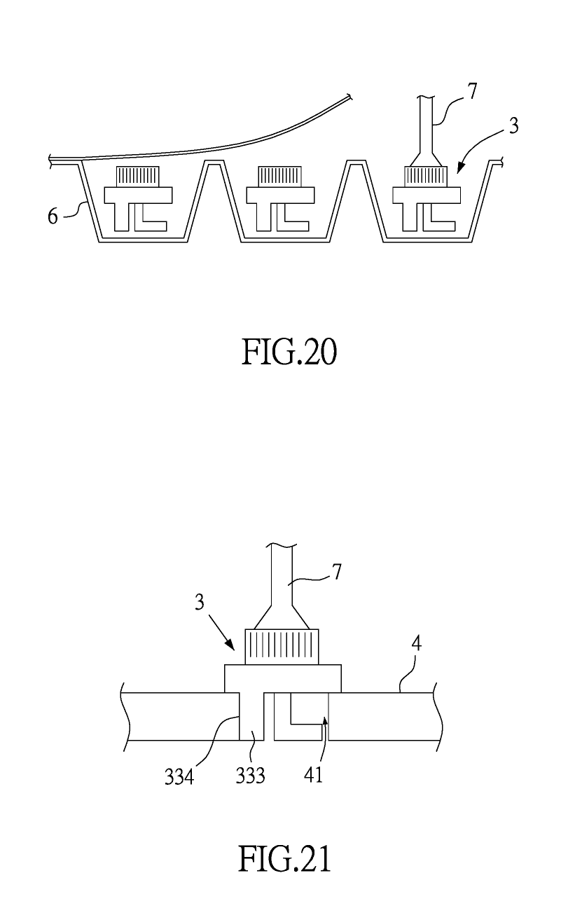

Please refer to FIGS. 20 and 21, which show the use of a rotary locking device 3 according to a ninth embodiment of the present invention. As shown, in the ninth embodiment, the rotary locking device 3 can be individually disposed on a carrier 6 and be removed from the carrier 6 using a tool for placing on and welding to an object 4. In the ninth embodiment, the rotary locking device 3 includes a connecting portion 333 that has a weldable surface 334. The weldable surface 334 can be heated for welding to a surface or a through hole 41 of the object 4.

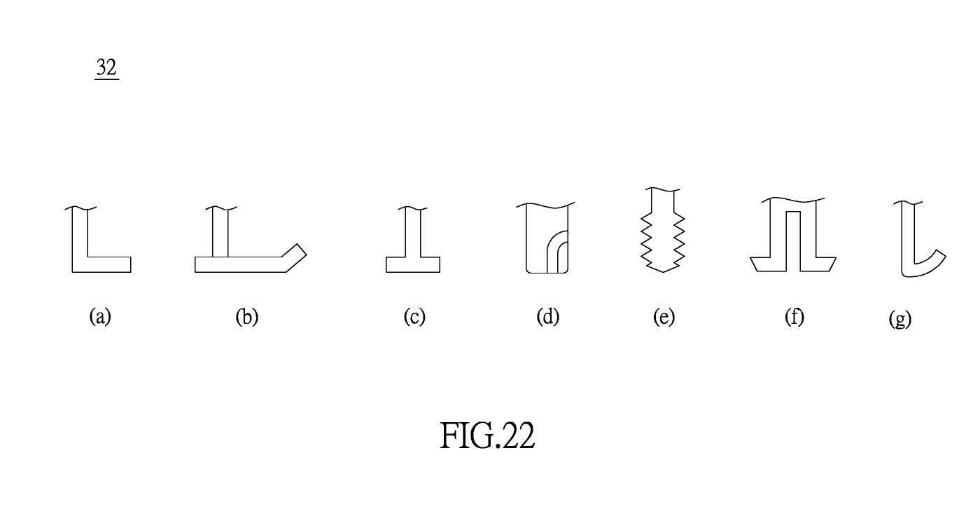

FIG. 22 shows examples of differently configured latch members 12, 22, 32 for the rotary locking device 1, 2, 3 of the present invention. As shown, the latch member 12, 22, 32 can be an L-shaped plate (see FIG. 22(a)), a tongue-like plate (see FIG. 22(b)), a male retaining member (see FIG. 22(c)), a female retaining member (see FIG. 22(d)), an externally threaded member (see FIG. 22(e)), an elastic fastening member (see FIG. 22(f)), a hook member (see FIG. 22(g)), an externally toothed member (not shown), a post-like member (not shown), or a block-like member (not shown).

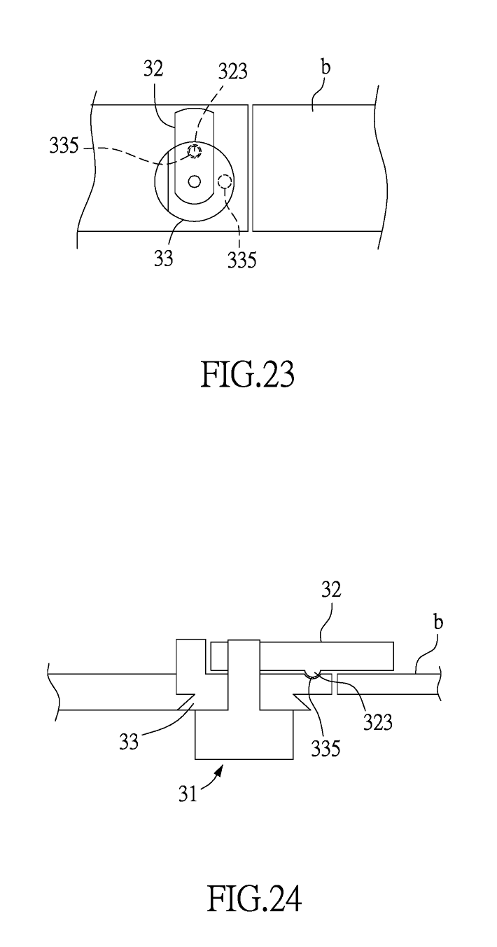

Please refer to FIGS. 23 and 24, which are rear view and sectional top view, respectively, of a rotary locking device 3 according to a tenth embodiment of the present invention. As shown, in the tenth embodiment, the rotary locking device 3 includes a thumbturn member 31, a limiting structure 33 provided with stopper-receiving sections 335, and a latch member 32 provided with a stopper 323 corresponding to the stopper-receiving sections 335. When the thumbturn member 31 brings the latch member 32 to turn, one of the stopper-receiving sections 335 can be aligned with the stopper 323 to interfere with the latter and accordingly, to hold the latch member 32 to a position relative to an object “b” to unlock or lock the object “b”.

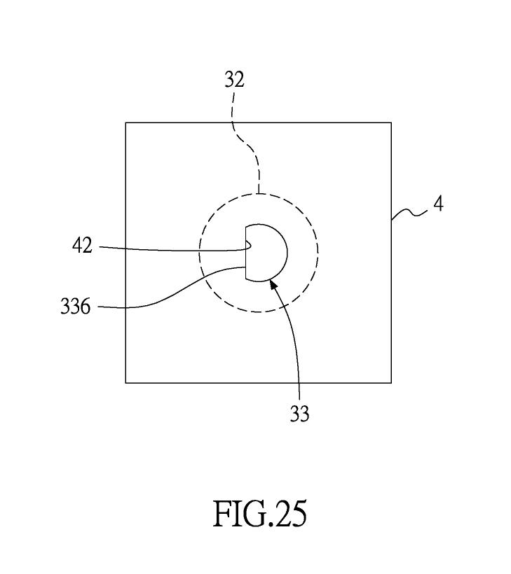

Please refer to FIG. 25, which shows a limiting structure 33 for a rotary locking device according to an eleventh embodiment of the present invention. As shown, in the eleventh embodiment, the limiting structure 33 has a connecting portion 333 provided with a directional section 336. When the connecting portion 333 is connected to an object 4, the directional section 336 matches a mating directional section 42 provided on the object 4 and thereby determines a directional position of the limiting structure relative to the object.

The present invention has been described with some preferred embodiments thereof and it is understood that the preferred embodiments are only illustrative and not intended to limit the present invention in any way and many changes and modifications in the described embodiments can be carried out without departing from the scope and the spirit of the invention that is intended to be limited only by the appended claims.

What is claimed is:

1. A rotary locking device, comprising:
a thumbturn member;
a latch member being held to and turnable by the thumbturn member; and
a limiting structure being provided on the thumbturn member for movably connecting to or interfering with the thumbturn member.

2. The rotary locking device as claimed in claim 1, wherein the thumbturn member includes a knob portion and a shaft portion connected to the knob portion.

3. The rotary locking device as claimed in claim 1, wherein the limiting structure includes a connecting portion.

4. The rotary locking device as claimed in claim 2, wherein the shaft portion is provided at an end with an engaging section for connecting to the latch member.

5. The rotary locking device as claimed in claim 4, wherein the engaging section can be any one of a toothed section, a threaded section, a fastening section, a recessed section, a protruded section and a post-shaped section.

6. The rotary locking device as claimed in claim 1, wherein the latch member is provided at an inner corner with a guide portion.

7. The rotary locking device as claimed in claim 1, wherein the limiting structure includes a body portion and a stop portion extended from and located at an end surface of the body portion, and the stop portion being used to limit the latch member from being rotated or to limit an angle by which the latch member can be rotated.

8. The rotary locking device as claimed in claim 1, further comprising an elastic element disposed between the thumbturn member and the latch member, or between the thumbturn member and the limiting structure, or between the limiting structure and the latch member.

9. The rotary locking device as claimed in claim 8, wherein the elastic element is selected from the group consisting of a torsion spring, a coil spring, a flat spring, a washer, a gasket and an elastic bar.

10. The rotary locking device as claimed in claim 3, wherein the connecting portion of the limiting structure is provided with a material retaining section that has a material retaining space formed thereon; and the material receiving space being able to flow into or fill with part of a material of an object via the limiting structure compressing the object and fixedly retain therein part of the material of the object, such that the connecting portion is firmly connected to the object.

11. The rotary locking device as claimed in claim 10, wherein the connecting portion is connected to and radially outward pressed against the object, such that part of the material of the object is forced into the material retaining space, enabling the connecting portion to be firmly held to the object.

12. The rotary locking device as claimed in claim 3, wherein the connecting portion is assembled to an object in a manner selected from the group consisting of riveting, expansion connection, screw-fastening, welding, snap-on fastening and glue bonding.

13. The rotary locking device as claimed in claim 10, wherein the material retaining space is formed around the connecting portion when a force is applied to the connecting portion by a pressing member, and the material retaining space so formed being able to retain therein part of the material of the object, enabling the connecting portion to be firmly held to the object.

14. The rotary locking device as claimed in claim 1, wherein the latch member has a configuration selected from the group consisting of an L-shaped plate, a tongue-like plate, a male retaining member, a female retaining member, an externally threaded member, an elastic fastening member, a hook member, an externally toothed member, a post-like member and a block-like member.

15. The rotary locking device as claimed in claim 3, wherein the connecting portion has a weldable surface, which can be heated for welding to a surface or a through hole of an object.

16. The rotary locking device as claimed in claim 15, wherein the rotary locking device can be individually disposed on a carrier and be removed from the carrier using a tool for placing on and welding to the object.

17. The rotary locking device as claimed in claim 7, wherein the latch member is provided with a mating stop portion for pressing against the stop portion of the limiting structure, so as to limit the angle by which the latch member can be rotated.

18. The rotary locking device as claimed in claim 1, wherein the limiting structure is provided with stopper-receiving sections and the latch member is provided with a stopper corresponding to the stopper-receiving sections; the stopper being able to be aligned with one of the stopper-receiving sections and be interfered by the stopper-receiving section, so that the latch member is held to a position relative to an object to unlock or lock the object.

19. The rotary locking device as claimed in claim 3, wherein the connecting portion of the limiting structure is provided with a directional section; and the directional section matching a mating directional section provided on an object when the connecting portion is connected to the object, and thereby determining a directional position of the limiting structure relative to the object.
